(19) United States
(12) Patent Application Publication
(10) Pub. No.: US 2024/0126132 A1
(43) Pub. Date: Apr. 18, 2024

(54) REFLECTIVE DISPLAY WITH COLOR COMPENSATION LAYER

(71) Applicant: E Ink Holdings Inc., HSINCHU (TW)

(72) Inventors: Jau-Min DING, HSINCHU (TW); Po-Yuan LO, HSINCHU (TW); Ian FRENCH, HSINCHU (TW)

(21) Appl. No.: 18/317,896

(22) Filed: May 15, 2023

(30) Foreign Application Priority Data
Oct. 17, 2022 (TW) 111139194

(51) Int. Cl. G02F 1/1677; G02F 1/1335; G02F 1/167; G02F 1/16755

(52) U.S. Cl. CPC G02F 1/1677; G02F 1/133514; G02F 1/167; G02F 1/16755; G02F 2201/52; G02F 2202/28; G02F 2203/02

(57) ABSTRACT

A reflective display with a color compensation layer includes a driving substrate, a display medium layer located on the driving substrate, a color filter array, an adhesive layer located on the display medium layer, and a color compensation layer. The driving substrate includes a first sub-pixel region, a second sub-pixel region, and a third sub-pixel region. The color filter array includes a red color resist, a green color resist, and a blue color resist. The color filter array and the color compensation layer are located at opposite two sides of the adhesive layer. The color compensation layer includes a first blue ink layer. A vertical projection of the green color resist on the driving substrate overlaps the second sub-pixel region. A vertical projection of the first blue ink layer on the driving substrate at least partially overlaps the second sub-pixel region.

### CROSS-REFERENCE TO RELATED APPLICATION

This application claims priority to Taiwan Application Serial Number 111139194, filed Oct. 17, 2022, which is herein incorporated by reference in its entirety.

### BACKGROUND

### Field of Invention

The present invention relates to a reflective display with a color compensation layer.

### Description of Related Art

The color electrophoresis display in the related art forms colorful figures by printing color filter layer to filter a light reflected by a display medium layer. Strip patterns in a white figure caused by reflectance deviation between color resists and color resist arrangement regularity may easily occur. However, if the pixel fill factor of a color resist is reduced, the color performance and white balance of the reflective display may be affected.

Accordingly, how to provide a reflective display which can overcome above problems is still one of the develop direction for those in the industry.

### SUMMARY

One aspect of the present disclosure provides a reflective display with a color compensation layer.

In one embodiment of the present disclosure, the reflective display with a color compensation layer includes a driving substrate, a display medium layer located on the driving substrate, a color filter array, an adhesive layer located on the display medium layer, and a color compensation layer. The driving substrate includes a first sub-pixel region, a second sub-pixel region, and a third sub-pixel region. The color filter array includes a red color resist, a green color resist, and a blue color resist. The color filter array and the color compensation layer are located at opposite two sides of the adhesive layer. The color compensation layer includes a first blue ink layer. A vertical projection of the green color resist on the driving substrate overlaps the second sub-pixel region. A vertical projection of the first blue ink layer on the driving substrate at least partially overlaps the second sub-pixel region.

In one embodiment of the present disclosure, the color compensation layer is located on a surface of the adhesive layer facing away from the display medium layer, and the color filter array is located on a surface of the display medium layer facing the adhesive layer.

In one embodiment of the present disclosure, the color compensation layer is located on a surface of the display medium layer facing the adhesive layer, and the color filter array is located on a surface of the adhesive layer facing away from the display medium layer.

In one embodiment of the present disclosure, the vertical projection of the first blue ink layer on the driving substrate is located within the second sub-pixel region.

In one embodiment of the present disclosure, the vertical projection of the first blue ink layer on the driving substrate is partially overlaps the third sub-pixel region.

In one embodiment of the present disclosure, the color compensation layer further includes a second blue ink layer, and a vertical projection of the second blue ink layer on the driving substrate at least partially overlaps the first sub-pixel region.

In one embodiment of the present disclosure, the color compensation layer further includes a third blue ink layer and a vertical projection of the third blue ink layer on the driving substrate at least partially overlaps the third sub-pixel region.

In one embodiment of the present disclosure, the vertical projection of the first blue ink layer on the driving substrate overlaps the first sub-pixel region and the third sub-pixel region.

In one embodiment of the present disclosure, the color compensation layer further comprises a first red ink layer, and a vertical projection of the first red ink layer on the driving substrate at least partially overlaps the second sub-pixel region.

In one embodiment of the present disclosure, the vertical projection of the first red ink layer on the driving substrate overlaps the first sub-pixel region.

In one embodiment of the present disclosure, a total area of the blue color resist and the firs blue ink layer is similar with to area of the green color resist.

In one embodiment of the present disclosure, a total area of the blue color resist and the firs blue ink layer is different from an area of the green color resist.

In one embodiment of the present disclosure, a white balance (a*, b*) is in a range of (±5, ±5).

Another aspect of the present disclosure is a reflective display with a color compensation layer.

In one embodiment of the present disclosure, the reflective display with a color compensation layer includes a driving substrate, a display medium layer located on the driving substrate, a color filter array, an adhesive layer located on the display medium layer, and a color compensation layer. The driving substrate includes a first sub-pixel region, a second sub-pixel region, and a third sub-pixel region. The color filter array includes a red color resist, a green color resist, and a blue color resist. The color filter array and the color compensation layer are located at opposite two sides of the adhesive layer. The color compensation layer includes a first blue ink layer. An vertical projection of the green color resist on the driving substrate and an vertical projection of the first blue ink layer on the driving substrate overlaps the same sub-pixel region, and a white balance (a*,b*) is in a range of (±5, ±5).

In one embodiment of the present disclosure, the vertical projection of the green color resist on the driving substrate overlaps the second sub-pixel region, and the vertical projection of the first blue ink layer on the driving substrate at least partially overlaps the second sub-pixel region.

In one embodiment of the present disclosure, the vertical projection of the first blue ink layer on the driving substrate is partially overlaps the third sub-pixel region.

In one embodiment of the present disclosure, the color compensation layer further comprises a second blue ink layer, and a vertical projection of the second blue ink layer on the driving substrate at least partially overlaps the first sub-pixel region.

In one embodiment of the present disclosure, the color compensation layer further comprises a third blue ink layer and a vertical projection of the third blue ink layer on the driving substrate at least partially overlaps the third sub-pixel region.

In one embodiment of the present disclosure, the vertical projection of the first blue ink layer on the driving substrate overlaps the first sub-pixel region and the third sub-pixel region.

In the aforementioned embodiments, the color compensation layer further comprises a first red ink layer, and a vertical projection of the first red ink layer on the driving substrate at least partially overlaps the second sub-pixel region.

According to the above embodiments, printing the first blue ink layer in the second sub-pixel region which corresponds to the green color resist by using a portion of the blue color resists can reduce the overall reflectance of the second sub-pixel region. Such design reduces the area of the blue color resist when viewed from top, and therefore the arrangement regularity between the color resists with different colors is reduced. As such, strip patterns in a white figure caused by reflectance deviation between color resists and color resist arrangement regularity can be avoided. Since the total area of the blue color resist and the first blue ink layer are similar to or substantially the same to the area of the green color resist and the area of the red color resist, the aforementioned configuration can maintain the white balance and color performance of the reflective display. In other words, color performance or white balance degradation caused by reduction of the total area of the blue color resist can be avoided by using a portion of the blue color resist as the first blue ink layer.

### BRIEF DESCRIPTION OF THE DRAWINGS

The invention can be more fully understood by reading the following detailed description of the embodiment, with reference made to the accompanying drawings as follows:

FIG. 1A is a top view of a reflective display according to one embodiment of the present disclosure;

FIG. 1B is a cross-sectional view of FIG. 1A;

FIG. 2A is a top view of another reflective display according to one embodiment of the present disclosure;

FIG. 2B is a cross-sectional view of FIG. 2A;

FIG. 3A is a top view of another reflective display according to one embodiment of the present disclosure;

FIG. 3B is a cross-sectional view of FIG. 3A;

FIG. 4A is a top view of another reflective display according to one embodiment of the present disclosure;

FIG. 4B is a cross-sectional view of FIG. 4A;

FIG. 5A is a top view of another reflective display according to one embodiment of the present disclosure;

FIG. 5B is a cross-sectional view of FIG. 5A;

FIG. 6 is a side view of another reflective display according to one embodiment of the present disclosure;

FIG. 7 is a side view of another reflective display according to one embodiment of the present disclosure;

FIG. 8 is a side view of another reflective display according to one embodiment of the present disclosure;

FIG. 9 is a side view of another reflective display according to one embodiment of the present disclosure;

FIG. 10 is a side view of another reflective display according to one embodiment of the present disclosure;

FIG. 11 is a side view of another reflective display according to one embodiment of the present disclosure; and

FIG. 12 is a side view of another reflective display according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

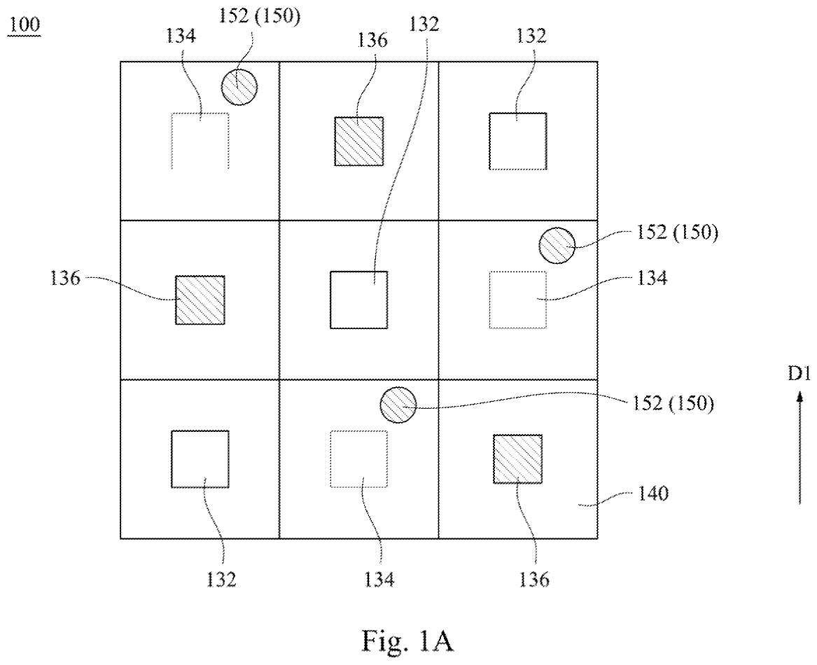

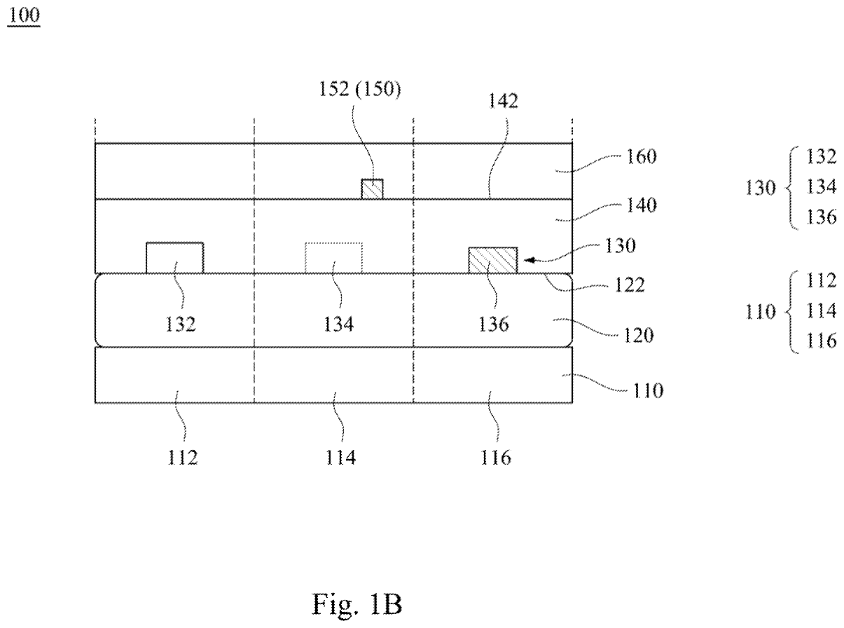

FIG. 1A is a top view of a reflective display 100 according to one embodiment of the present disclosure. FIG. 1B is a cross-sectional view of FIG. 1A. The viewing angle in FIG. 1B corresponds to a cross-sectional view of the reflective display 100 along a direction D1 in FIG. 1A. Reference is made to FIG. 1A and FIG. 1B. The reflective display 100 includes a driving substrate 110, a display medium layer 120, a color filter array 130, an adhesive layer 140, a color compensation layer 150, and a cover 160. In the present embodiment, the reflective display 100 is an electrophoresis display (EPD). The display medium layer 120 includes capsules. The adhesive layer 140 is an optical clear adhesive. For convenience, the cover 160 is omitted in FIG. 1A, and the color filter array 130 located below the adhesive layer 140 is illustrated by solid lines.

The driving substrate 110 includes a first sub-pixel region 112, a second sub-pixel region 114, and a third sub-pixel region 116. The display medium layer 120 is located on the driving substrate 110. The color filter array 130 and the color compensation layer 150 are located at opposite two sides of the adhesive layer 140. The adhesive layer 140 is located on the display medium layer 120. In the present embodiment, the color filter array 130 is located on a surface 122 of the display medium layer 120 facing the adhesive layer 140. The color filter array 130 includes a red color resist 132, a green color resist 134, and a blue color resist 136. The adhesive layer 140 covers the display medium layer 120 and the color filter array 130. The color compensation layer 150 is located on the adhesive layer 140. Specifically, the color compensation layer 150 is located on a surface 142 of the adhesive layer 140 facing away from the display medium layer 120. The color compensation layer 150 is formed by printing. The cover 160 includes transparent substrate. It is noted that there can be other laminated structures between the color compensation layer 150 and the cover 160 of the present embodiment, and the present disclosure is not limited in these regards.

In the present embodiment, the color compensation layer 150 includes a first blue ink layer 152. A vertical projection of the red color resist 132 on the driving substrate 110 overlaps the first sub-pixel region 112. Vertical projections of the green color resist 134 and the first blue ink layer 152 on the driving substrate 110 overlaps the second sub-pixel region 114. In the present embodiment, a vertical projection of the first blue ink layer 152 on the driving substrate 110 is within the second sub-pixel region 114, but the present disclosure is not limited in this regard. A vertical projection of the blue color resist 136 on the driving substrate 110 overlaps the third sub-pixel region 116.

A white balance (a*, b*) of the reflective display 100 is in a range of (±5, ±5). The symbol a* and b* represents the coordinates in the CIELab color space. The material of the first blue ink layer 152 and the material of the blue color resist 136 are the same. Specifically, a total area of the blue color resist 136 and the first blue ink layer 152 is substantially similar to or the same as an area of the green color resist 134. In other words, the first blue ink layer 152 can be considered as being formed by moving a portion of the blue color resist 136 onto the surface 142 of the adhesive layer 140. In the present embodiment, a total area of the blue color resist 136 and the first blue ink layer 152 is substantially similar to or the same as an area of the red color resist 132. The area of the green color resist 134 is substantially similar to or the same as the area of the red color resist 132. If the ink concentration changes, then total area of the blue color resist 136 and the first blue ink layer 152 may be different from the area of the green color resist 134. That is, total areas of each of the color resists depend on the color performance of the ink for each color resists. Therefore, the areas of each of the color resists may vary as long as the white balance is in the range of (+5, +5).

In general, the reflectance of the green color resist 134 is greater than the reflectance of the red color resist 132 and the blue color resist 136, and the reflectance of the blue color resist 136 is obviously lower than the reflectance of the green color resist 134. For example, the reflectance of the blue color resist 136 is about 19% to 22%, the reflectance of the red color resist 132 is about 22.5% to 25.5%, and the reflectance of the green color resist 134 is about 63% to 66%. Therefore, printing the first blue ink layer 152 in the second sub-pixel region 114 which corresponds to the green color resist 134 by using a portion of the blue color resists 136 can reduce the overall reflectance of the second sub-pixel region 114. For example, comparing with a reflective display without the color compensation layer 150, a reflectance ratio between the green sub-pixel (i.e., the second sub-pixel region 114) and the blue sub-pixel (i.e., the third sub-pixel region 116) of the reflective display 100 can be reduced from 132.3% to 101.2%. Comparing to a design without the color compensation layer 150, the contrast of the reflective display 100 can be enhanced from 13.29% to 18.97%. In addition, such design reduces the area of the blue color resist 136 when viewed from top, and therefore the arrangement regularity between the color resists with different colors is reduced. As such, strip patterns in a white figure caused by reflectance deviation between color resists and color resist arrangement regularity can be avoided.

Since the total area of the blue color resist 136 and the first blue ink layer 152 remain the same and the area of the green color resist 134 and the area of the red color resist 132 are similar to or substantially the same, the aforementioned configuration can maintain the white balance and color performance of the reflective display 100. In other words, color performance or white balance degradation caused by reduction of the total area of the blue color resist 136 can be avoided by using a portion of the blue color resist 136 as the first blue ink layer 152.

As shown in FIG. 1A, the vertical projection of the first blue ink layer 152 on the driving substrate 110 does not overlap the vertical projection of the green color resist 134 on the driving substrate 110, but the present disclosure is not limited in this regard. In other embodiments, the vertical projection of the first blue ink layer 152 on the driving substrate 110 partially overlaps or entirely overlaps the vertical projection of the green color resist 134 on the driving substrate 110. In the present embodiment, an area of the green color resist 134 is greater than an area of the first blue ink layer 152, but the present disclosure is not limited in this regard. Specifically, the area of the color resists of the color filter array 130 and the area of the ink layers of the color compensation layer 150 when viewed from top are not limited as long as the total area of the first blue ink layer 152 and the blue color resists 136 can maintain the white balance and color performance of the reflective display 100.

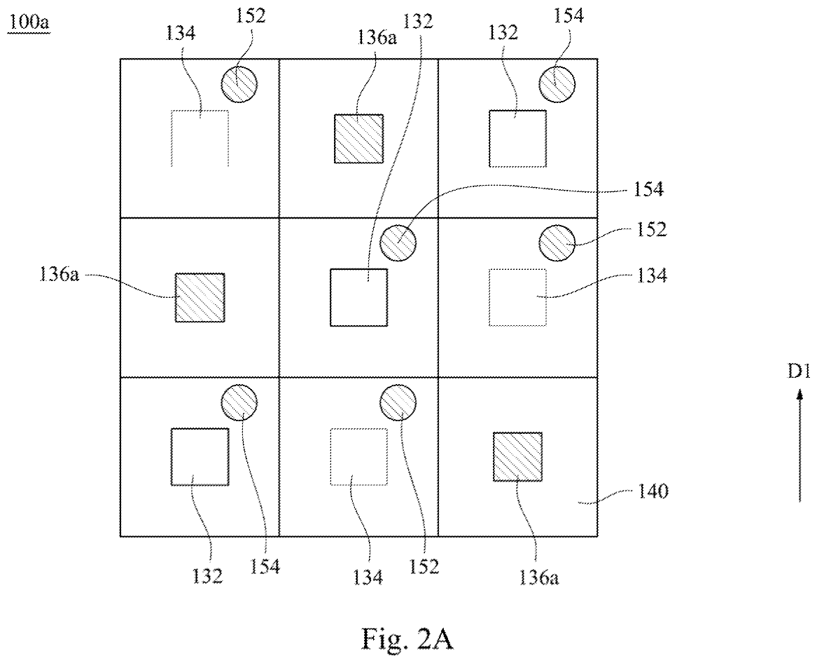

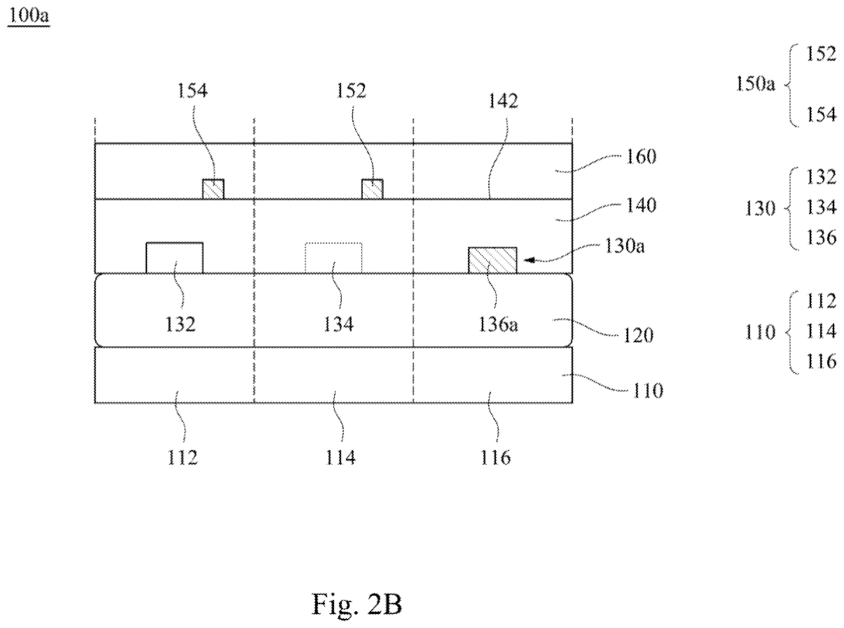

FIG. 2A is a top view of another reflective display 100a according to one embodiment of the present disclosure. FIG. 2B is a cross-sectional view of FIG. 2A. The viewing angle in FIG. 2B corresponds to a cross-sectional view of the reflective display 100a along a direction D1 in FIG. 2A. Reference is made to FIG. 2A and FIG. 2B. The reflective display 100a is similar to the reflective display 100 in FIG. 1A, and the difference is that the color compensation layer 150a of the reflective display 100a further includes a second blue ink layer 154, and the area of the blue color resist 136a of the color filter array 130a is smaller than the area of the blue color resist 136 of the reflective display 100 mentioned above. A vertical projection of the second blue ink layer 154 on the driving substrate 110 at least partially overlaps the second sub-pixel region 112. In the present embodiment, the vertical projection of the second blue ink layer 154 on the driving substrate 110 is within the first sub-pixel region 112, but the present disclosure is not limited in this regard.

Printing the first blue ink layer 152 in the second sub-pixel region 114 which corresponds to the green color resist 134 by using a portion of the blue color resists 136a and printing the second blue ink layer 154 in the first sub-pixel region 112 which corresponds to the red color resist 132 by using another portion of the blue color resist 136a can reduce the overall reflectance of the first sub-pixel region 112 and the second sub-pixel region 114. The reflective display 100a and the reflective display 100 mentioned above have the same technical advantages, and therefore the description is not repeated hereinafter.

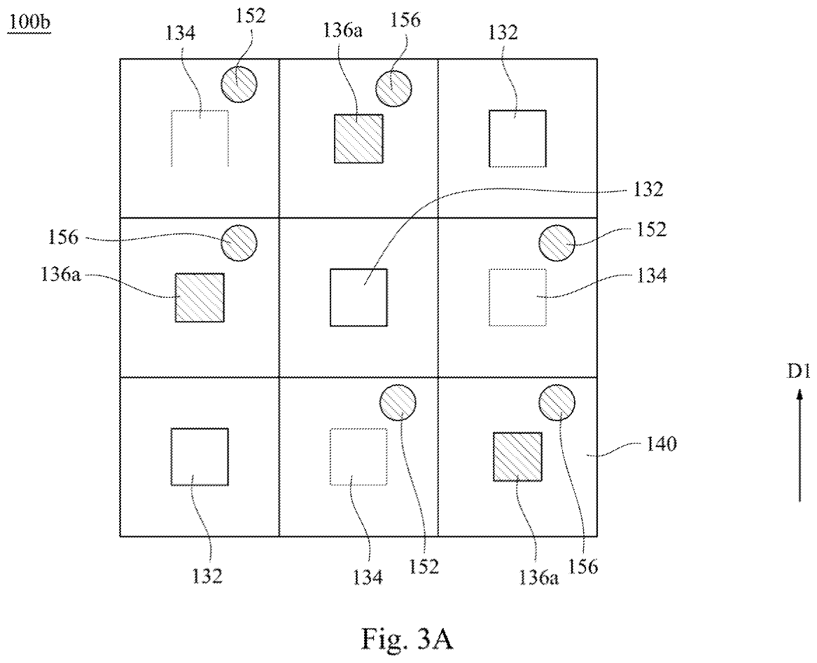

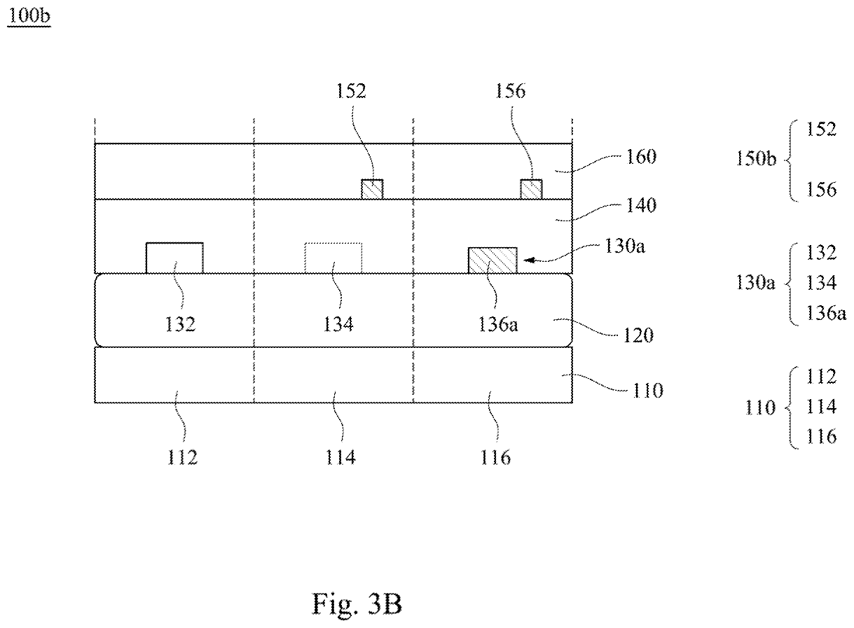

FIG. 3A is a top view of another reflective display 100b according to one embodiment of the present disclosure. FIG. 3B is a cross-sectional view of FIG. 3A. The viewing angle in FIG. 3B corresponds to a cross-sectional view of the reflective display 100b along a direction D1 in FIG. 3A. Reference is made to FIG. 3A and FIG. 3B. The reflective display 100b is similar to the reflective display 100 in FIG. 1A, and the difference is that the color compensation layer 150b of the reflective display 100b further includes a third blue ink layer 156, and an area of the blue color resist 136a of the color filter array 130a is smaller than the area of the blue color resist 136 of the reflective display 100 mentioned above. A vertical projection of the third blue ink layer 156 on the driving substrate 110 at least partially overlaps the third sub-pixel region 116. In the present embodiment, the vertical projection of the third blue ink layer 156 on the driving substrate 110 is within the third sub-pixel region 116, but the present disclosure is not limited in this regard.

In the present embodiment, printing the first blue ink layer 152 in the second sub-pixel region 114 which corresponds to the green color resist 134 by using a portion of the blue color resists 136a can reduce the overall reflectance of the second sub-pixel region 114. Printing the third blue ink layer 156 by using a portion of the blue color resists 136a does not affect the overall reflectance of the third sub-pixel region 116. However, the area of the blue color resist 136a is smaller than the area of the green color resist 134 and the area of the red color resist 132 in the present embodiment, which is beneficial to reduce the arrangement regularity between the color resists with different colors. The reflective display 100b and the reflective display 100 mentioned above have the same technical advantages, and therefore the description is not repeated hereinafter.

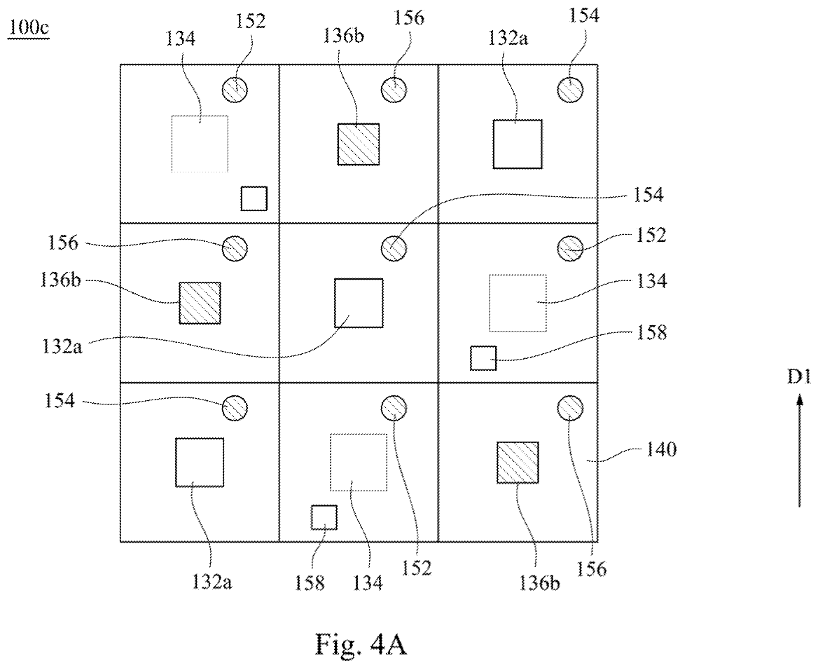

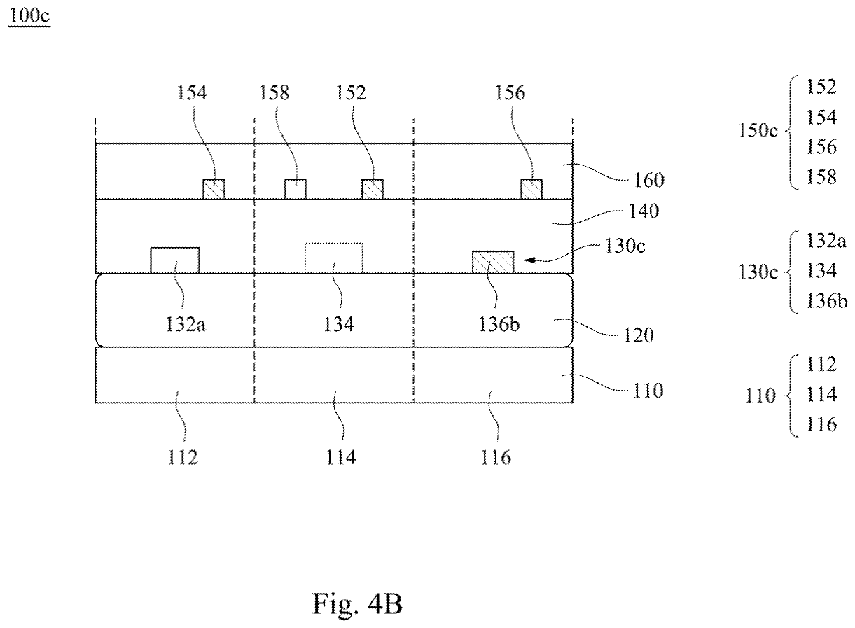

FIG. 4A is a top view of another reflective display 100c according to one embodiment of the present disclosure. FIG. 4B is a cross-sectional view of FIG. 4A. The viewing angle in FIG. 4B corresponds to a cross-sectional view of the reflective display 100c along a direction D1 in FIG. 4A. Reference is made to FIG. 4A and FIG. 4B. The reflective display 100c is similar to the reflective display 100a in FIG. 2A, and the difference is that the color compensation layer 150c of the reflective display 100c further includes a third blue ink layer 156 and a first red ink layer 158. An area of the blue color resist 136b of the color filter array 130c is smaller than the area of the blue color resist 136a of the reflective display 100a mentioned above, and an area of the red color resist 132a of the color filter array 130c is smaller than the red color resist 132 of the reflective display 100a mentioned above as well. A vertical projection of the first red ink layer 158 on the driving substrate 110 at least partially overlaps the second sub-pixel region 114. In the present embodiment, the vertical projection of the first red ink layer 158 on the driving substrate 110 is within the second sub-pixel region 114, but the present disclosure is not limited in this regard. The vertical projection of the first red ink layer 158 on the driving substrate 110 does not overlap the vertical projection of the green color resist 134 on the driving substrate 110, but the present disclosure is not limited in this regard.

Since the reflectance of the red color resist 132a is lower than the reflectance of the green color resist 134, the overall reflectance of the second sub-pixel region 114 can be further reduced by printing a portion of the blue color resist 136b and a portion of the red color resist 132a to the second sub-pixel region 114 which corresponds to the green color resist 134. The overall reflectance of the first sub-pixel region 112 can be reduced by printing the second blue ink layer 154 to the first sub-pixel region 112 which corresponds to the red color resist 132a by using another portion of the blue color resist 136b. In other words, the color compensation layer 150c can have ink layers with different colors, which can be used in combination to reduce the reflectance deviation between the color resists with different colors. The reflective display 100c and the reflective display 100a mentioned above have the same technical advantages, and therefore the description is not repeated hereinafter.

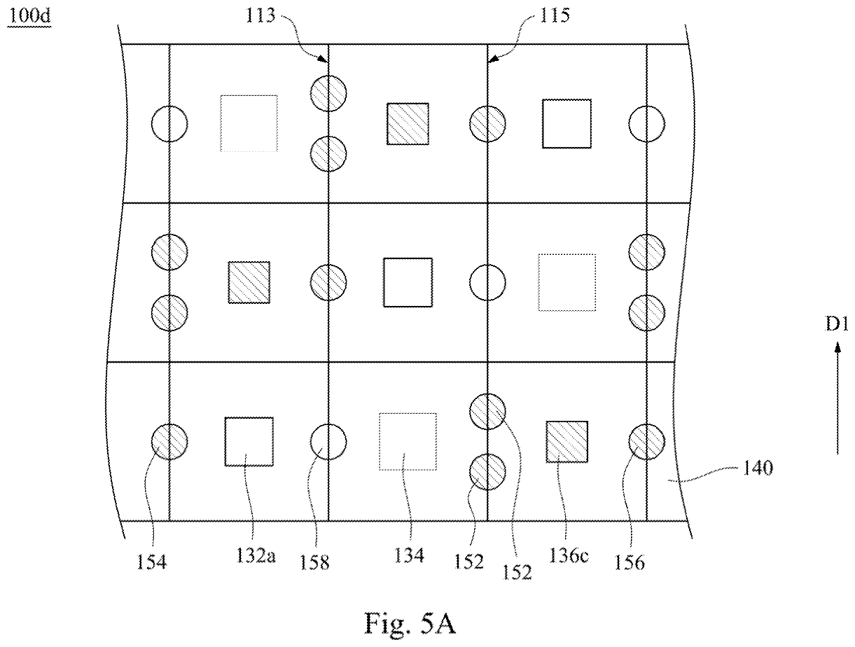

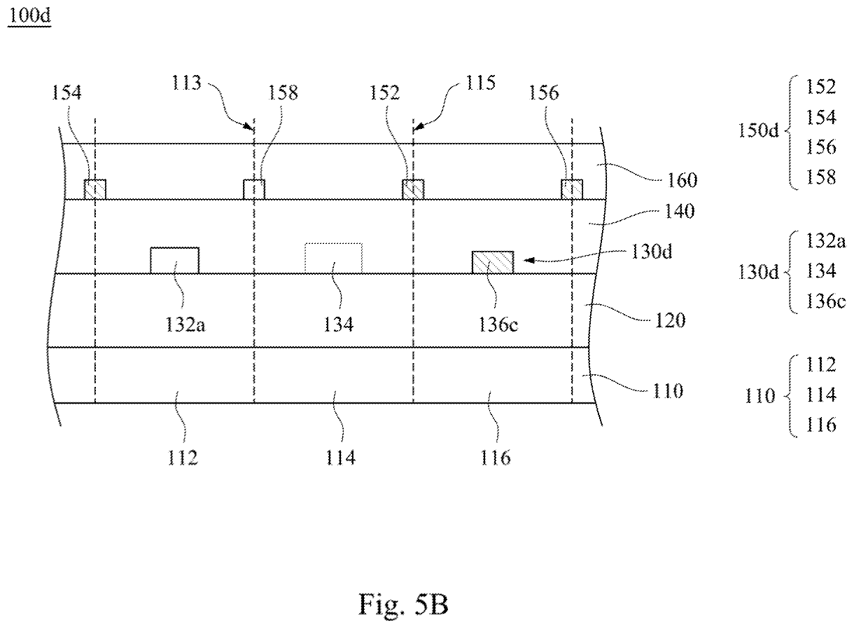

FIG. 5A is a top view of another reflective display 100d according to one embodiment of the present disclosure. FIG. 5B is a cross-sectional view of FIG. 5A. The viewing angle in FIG. 5B corresponds to a cross-sectional view of the reflective display 100d along a direction D1 in FIG. 5A. Reference is made to FIG. 5A and FIG. 5B. The reflective display 100d is similar to the reflective display 100c in FIG. 4A, and the difference is that the color compensation layer 150d of the reflective display 100d includes two first blue ink layer 152, and an area of the blue color resist 136c of the color filter array 130d is smaller than the area of the blue color resist 136b of the reflective display 100c mentioned above.

In the present embodiment, a vertical projection of the first blue ink layer 152 on the driving substrate 110 is located at the interface 115 between the second sub-pixel region 114 and the third sub-pixel region 116. A vertical projection of the first red ink layer 158 on the driving substrate 110 is located at the interface 113 between the first sub-pixel region 112 and the second sub-pixel region 114. Similarly, a vertical projection of the second blue ink layer 154 on the driving substrate 110 is located at the interface between the first sub-pixel region 112 and another sub-pixel region at the left-hand side (not shown). A vertical projection of the third blue ink layer 156 is located at the interface between the third sub-pixel region 116 and another sub-pixel region at the right-hand side (not shown).

In the present embodiment, since a portion of the first red ink layer 158 and a portion of the second blue ink layer 154 are located in the first sub-pixel region 112 which corresponds to the red color resist 132, the overall reflectance of the first sub-pixel region 112 can be adjusted to a proper value. For example, when a vertical projection of the entire second ink layer 154 on the driving substrate 110 is in the first sub-pixel region 112, the reflectance of the first sub-pixel region 112 may be reduced too much. Therefore, the design of the reflective display 100d can partially reduce such influence from the second blue ink layer 154 and compensate the reflectance loss of the first sub-pixel region 112 through the first red ink layer 158 at the same time. In other words, by adjusting positions of the ink layers of the color compensation layer 150d can further fine-tune the reflectance of the sub-pixel regions so as to reduce reflectance deviation between the color resists with different colors. The reflective display 100d and the reflective display 100c mentioned above have the same technical advantages, and therefore the description is not repeated hereinafter.

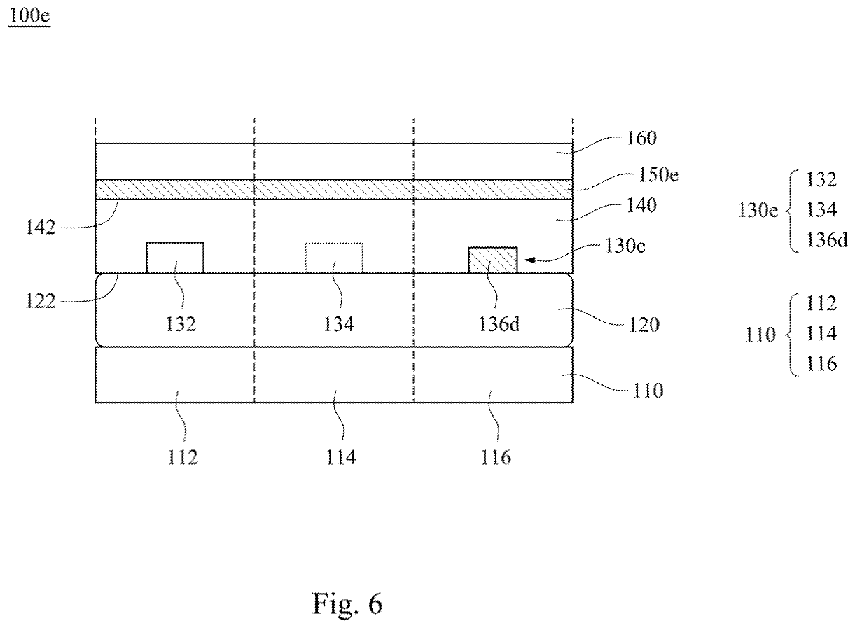

FIG. 6 is a side view of another reflective display 100e according to one embodiment of the present disclosure. The reflective display 100e is similar to the reflective display 100 in FIG. 1B, and the difference is that a vertical projection of the color compensation layer 150e of the reflective display 100e on the driving substrate 110 overlaps the first sub-pixel region 112 and the third sub-pixel region 116, and the area of the blue color resist 136d of the color filter array 130e is smaller than the area of the blue color resist 136c of the reflective display 100d mentioned above.

In the present embodiment, the color compensation layer 150e of the reflective display 100e is an ink layer that covers the entire surface 142 of the adhesive layer 140. Such design may reduce the process complexity and reduce the reflectance deviation between the color resists with different colors. In other embodiments, the color compensation layer 150e of the reflective display 100e can be disposed between the adhesive layer 140 and the display medium layer 120. In other words, the color compensation layer 150e can cover the entire surface of the adhesive layer 140 facing the display medium layer 120 or cover the entire surface 122 of the display medium layer 120. As described above, the color compensation layer 150e can be used in combination with the first red ink layer 158 mentioned above (see FIG. 4B) so as to fine-tune the reflectance of the sub-pixel regions. The reflective display 100e and the reflective display 100 mentioned above have the same technical advantages, and therefore the description is not repeated hereinafter.

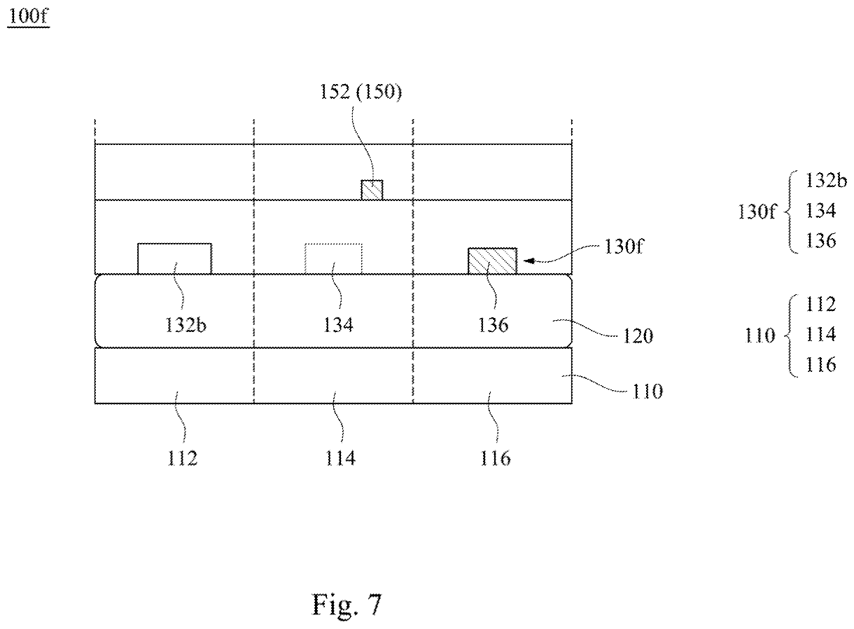

FIG. 7 is a side view of another reflective display 100f according to one embodiment of the present disclosure. The reflective display 100f is similar to the reflective display 100 in FIG. 1B, and the difference is that the area of the red color resist 132b of the reflective display 100f is different form the area of the green color resist 134 of the reflective display 100f. In addition, the area of the red color resist 132b is different from the total are of the first blue ink layer 152 and the blue color resist 136. In the present embodiment, the area of the red color resist 132b is slightly greater than the area of the green color resist 134 so as to reduce the reflectance of the first sub-pixel region 112. In other embodiment, the second blue ink layer 154 shown in FIG. 2B can be combined so as to reduce the reflectance of the first sub-pixel region 112 and reduce the area of the red color resist 132b to avoid large reflectance reduction. In other words, the configurations of the color compensation layer 150 can match the color filter array 130f. The reflective display 100f and the reflective display 100 mentioned above have the same technical advantages, and therefore the description is not repeated hereinafter.

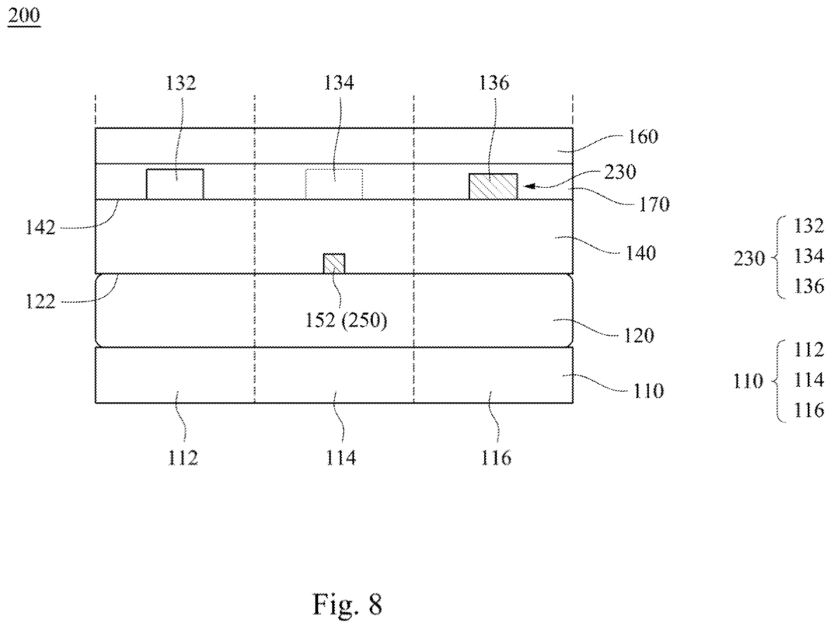

FIG. 8 is a side view of another reflective display 200 according to one embodiment of the present disclosure. The reflective display 200 includes a driving substrate 110, a display medium layer 120, a color filter array 230, an adhesive layer 140, a color compensation layer 250, and a cover 160. The reflective display 200 further includes another adhesive layer 170 located between the color filter array 230 and the cover 160, but the present disclosure is not limited in this regard. There can be other laminated structures between the color filter array 230 and the cover 160 of the present embodiment based on practical requirements, and the present disclosure is not limited in these regards.

In the present embodiment, the color compensation layer 250 is located on the surface 122 of the display medium layer 120 facing the adhesive layer 140. In other words, the color compensation layer 250 is located between the adhesive layer 140 and the display medium layer 120, and the adhesive layer 140 surrounds the color compensation layer 250. The color filter array 230 is located on the surface 142 of the adhesive layer 140 facing away from the display medium layer 120. The structures of the color filter array 230 are the same as those of the color filter array 130 shown in FIG. 1B, and the color filter array 230 of the reflective display 200 includes the red color resist 132, the green color resist 134, and the blue color resist 136 the same as those of the color filter array 130 shown in FIG. 1B. The color compensation layer 250 and the color compensation layer 150 shown in FIG. 1B have similar first blue ink layer 152.

In the present embodiment, the vertical projection of the first blue ink layer 152 on the driving substrate 110 overlaps the vertical projection of the green color resist 134 on the driving substrate 110, but the present disclosure is not limited in this regard. The top view of the reflective display 200 in FIG. 8 is substantially the same as FIG. 1A, and the difference is that the areas of the first blue ink layer 152 and the green color resists 134 when viewed from top overlap with each other, and therefore the top view is omitted here. The reflective display 200 and the reflective display 100 mentioned above have the same technical advantages, and therefore the description is not repeated hereinafter.

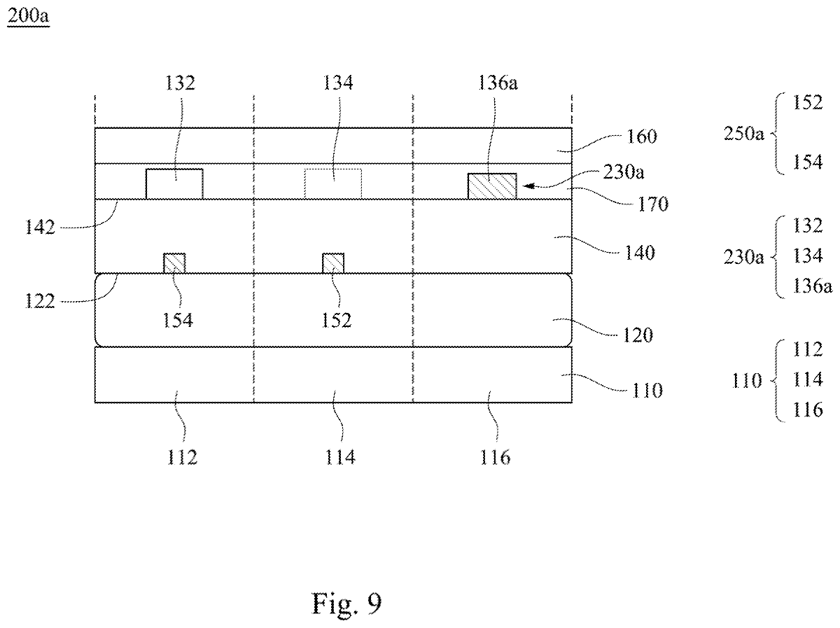

FIG. 9 is a side view of another reflective display 200a according to one embodiment of the present disclosure. The reflective display 200a is similar to the reflective display 200 shown in FIG. 8, and the difference is that the color compensation layer 250a of the reflective display 200a includes the first blue ink layer 152 similar with that of the color compensation layer 150a and the color filter array 230a of the reflective display 200a includes the red color resist 132, the green color resist 134, and the blue color resist 136a the same as those of the color filter array 130a shown in FIG. 2B. In the present embodiment, the vertical projection of the first blue ink layer 152 on the driving substrate 110 overlaps the vertical projection of the green color resist 134 on the driving substrate 110, and the vertical projections of the second blue ink layer 154 and the red color resist 132 on the driving substrate 110 overlaps with each other, but the present disclosure in not limited in these regards. The reflective display 200a and the reflective display 200 mentioned above have the same technical advantages, and therefore the description is not repeated hereinafter.

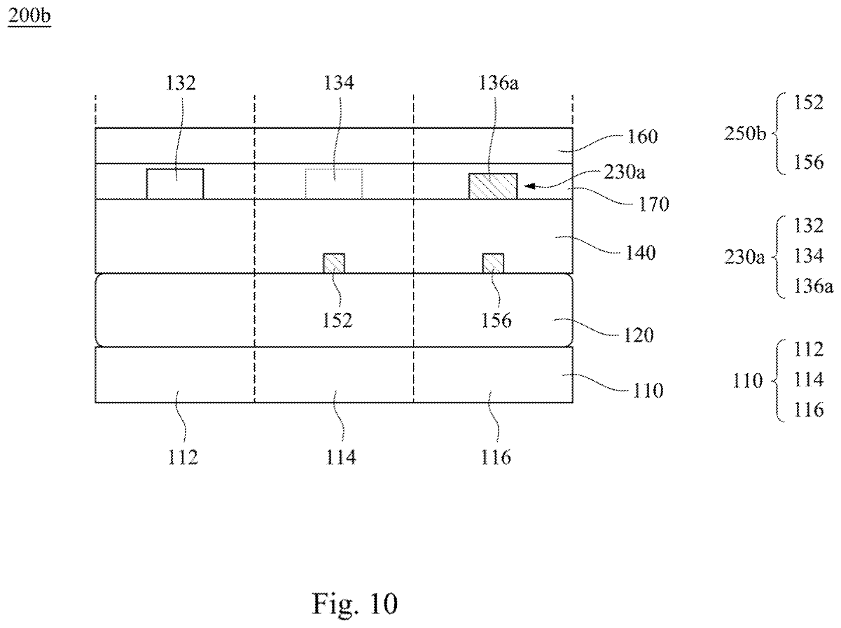

FIG. 10 is a side view of another reflective display 200b according to one embodiment of the present disclosure. The reflective display 200b is similar to the reflective display 200 shown in FIG. 8, and the difference is that the color compensation layer 250b of the reflective display 200b includes the first blue ink layer 152 and the third blue ink layer 156 the same as those of the color compensation layer 150b shown in FIG. 3B. In the present embodiment, the vertical projection of the third blue ink layer 156 on the driving substrate 110 overlaps the vertical projection of the blue color resist 136a on the driving substrate 110, but the present disclosure in not limited in these regards. The reflective display 200b and the reflective display 200 mentioned above have the same technical advantages, and therefore the description is not repeated hereinafter.

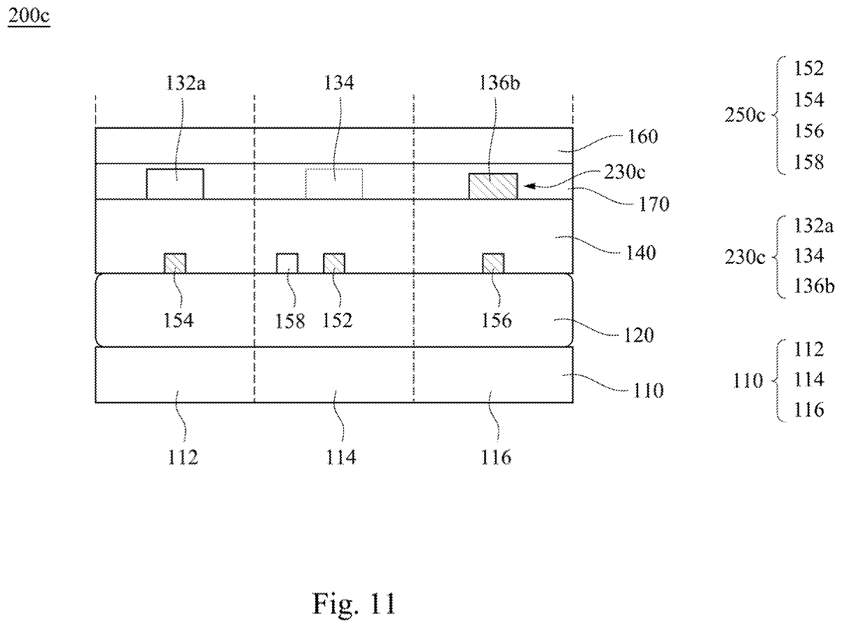

FIG. 11 is a side view of another reflective display 200c according to one embodiment of the present disclosure. The reflective display 200c is similar to the reflective display 200a shown in FIG. 9, and the difference is that the color compensation layer 250c of the reflective display 200c includes the third blue ink layer 156 and the first red ink layer 158 the same as those of the color compensation layer 150c shown in FIG. 4B, and the color filter array 230c of the reflective display 200c includes the red color resist 132a and the blue color resist 136b the same as those of the color filter array 130c shown in FIG. 4B. In the present embodiment, the vertical projection of the third blue ink layer 156 on the driving substrate 110 overlaps the vertical projection of the blue color resist 136b on the driving substrate 110, but the present disclosure in not limited in these regards. The reflective display 200c and the reflective display 200a mentioned above have the same technical advantages, and therefore the description is not repeated hereinafter.

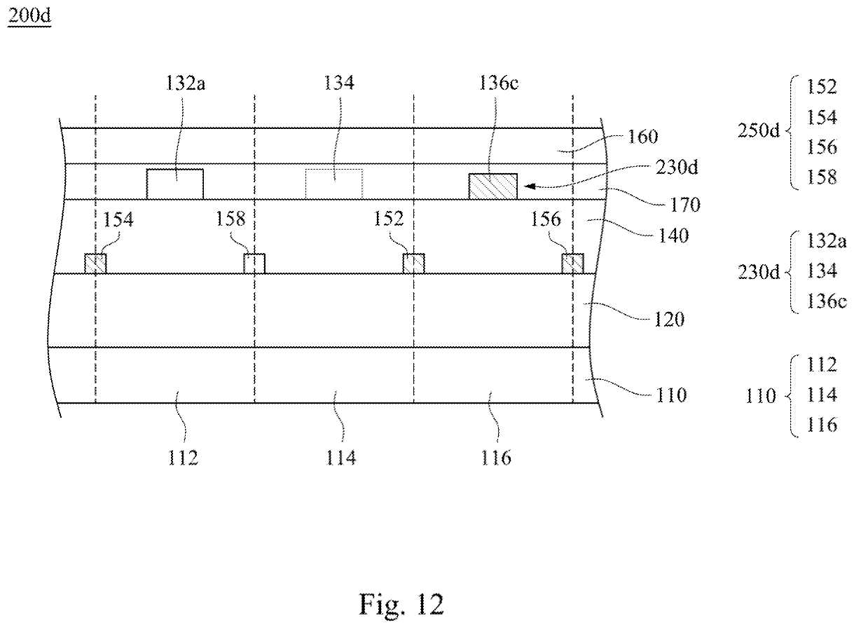

FIG. 12 is a side view of another reflective display 200d according to one embodiment of the present disclosure. The reflective display 200d is similar to the reflective display 200c shown in FIG. 11, and the difference is that the color compensation layer 250d of the reflective display 200d further includes two first blue ink layers 152 the same as those of the color compensation layer 150d shown in FIG. 5A and FIG. 5B, and the color filter array 230d of the reflective display 200d includes the blue color resist 136c the same as those of the color filter array 130d shown in FIG. 5B. The reflective display 200d and the reflective display 200a mentioned above have the same technical advantages, and therefore the description is not repeated hereinafter.

In summary, printing the first blue ink layer in the second sub-pixel region which corresponds to the green color resist by using a portion of the blue color resists can reduce the overall reflectance of the second sub-pixel region. Such design reduces the area of the blue color resist when viewed from top, and therefore the arrangement regularity between the color resists with different colors is reduced. As such, strip patterns in a white figure caused by reflectance deviation between color resists and color resist arrangement regularity can be avoided. Since the total area of the blue color resist and the first blue ink layer are similar to or substantially the same to the area of the green color resist and the area of the red color resist, the aforementioned configuration can maintain the white balance and color performance of the reflective display. In other words, color performance or white balance degradation caused by reduction of the total area of the blue color resist can be avoided by using a portion of the blue color resist as the first blue ink layer.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A reflective display with a color compensation layer, comprising:
a driving substrate comprising a first sub-pixel region, a second sub-pixel region, and a third sub-pixel region;
a display medium layer located on the driving substrate;
a color filter array comprising a red color resist, a green color resist, and a blue color resist;
an adhesive layer located on the display medium layer; and
a color compensation layer, wherein the color filter array and the color compensation layer are located at two opposite sides of the adhesive layer, the color compensation layer comprises a first blue ink layer, an vertical projection of the green color resist on the driving substrate overlaps the second sub-pixel region, and an vertical projection of the first blue ink layer on the driving substrate at least partially overlaps the second sub-pixel region.

2. The reflective display with a color compensation layer of claim 1, wherein the color compensation layer is located on a surface of the adhesive layer facing away from the display medium layer, and the color filter array is located on a surface of the display medium layer facing the adhesive layer.

3. The reflective display with a color compensation layer of claim 1, wherein the color compensation layer is located on a surface of the display medium layer facing the adhesive layer, and the color filter array is located on a surface of the adhesive layer facing away from the display medium layer.

4. The reflective display with a color compensation layer of claim 1, wherein the vertical projection of the first blue ink layer on the driving substrate is located within the second sub-pixel region.

5. The reflective display with a color compensation layer of claim 1, wherein the vertical projection of the first blue ink layer on the driving substrate is partially overlaps the third sub-pixel region.

6. The reflective display with a color compensation layer of claim 1, wherein the color compensation layer further comprises a second blue ink layer, and a vertical projection of the second blue ink layer on the driving substrate at least partially overlaps the first sub-pixel region.

7. The reflective display with a color compensation layer of claim 1, wherein the color compensation layer further comprises a third blue ink layer and a vertical projection of the third blue ink layer on the driving substrate at least partially overlaps the third sub-pixel region.

8. The reflective display with a color compensation layer of claim 1, wherein the vertical projection of the first blue ink layer on the driving substrate overlaps the first sub-pixel region and the third sub-pixel region.

9. The reflective display with a color compensation layer of claim 1, wherein the color compensation layer further comprises a first red ink layer, and a vertical projection of the first red ink layer on the driving substrate at least partially overlaps the second sub-pixel region.

10. The reflective display with a color compensation layer of claim 9, wherein the vertical projection of the first red ink layer on the driving substrate overlaps the first sub-pixel region.

11. The reflective display with a color compensation layer of claim 1, wherein a total area of the blue color resist and the first blue ink layer is similar with to area of the green color resist.

12. The reflective display with a color compensation layer of claim 1, wherein a total area of the blue color resist and the firs blue ink layer is different from an area of the green color resist.

13. The reflective display with a color compensation layer of claim 1, wherein a white balance (a*, b*) is in a range of (±5, ±5).

14. A reflective display with a color compensation layer, comprising:
a driving substrate comprising a first sub-pixel region, a second sub-pixel region, and a third sub-pixel region;
a display medium layer located on the driving substrate;
a color filter array comprising a red color resist, a green color resist, and a blue color resist;
an adhesive layer located on the display medium layer; and
a color compensation layer, wherein the color filter array and the color compensation layer are located at two opposite sides of the adhesive layer, the color compensation layer comprises a first blue ink layer, an vertical projection of the green color resist on the driving substrate and an vertical projection of the first blue ink layer on the driving substrate overlaps the same sub-pixel region, and a white balance (a*, b*) is in a range of (±5, ±5).

15. The reflective display with a color compensation layer of claim 14, wherein the vertical projection of the green color resist on the driving substrate overlaps the second sub-pixel region, and the vertical projection of the first blue ink layer on the driving substrate at least partially overlaps the second sub-pixel region.

16. The reflective display with a color compensation layer of claim 14, wherein the vertical projection of the first blue ink layer on the driving substrate is partially overlaps the third sub-pixel region.

17. The reflective display with a color compensation layer of claim 14, wherein the color compensation layer further comprises a second blue ink layer, and a vertical projection of the second blue ink layer on the driving substrate at least partially overlaps the first sub-pixel region.

18. The reflective display with a color compensation layer of claim 14, wherein the color compensation layer further comprises a third blue ink layer and a vertical projection of the third blue ink layer on the driving substrate at least partially overlaps the third sub-pixel region.

19. The reflective display with a color compensation layer of claim 14, wherein the vertical projection of the first blue ink layer on the driving substrate overlaps the first sub-pixel region and the third sub-pixel region.

20. The reflective display with a color compensation layer of claim 14, wherein the color compensation layer further comprises a first red ink layer, and a vertical projection of the first red ink layer on the driving substrate at least partially overlaps the second sub-pixel region.
